(19) United States
(12) Patent Application Publication
(10) Pub. No.: US 2025/0190140 A1
(43) Pub. Date: Jun. 12, 2025

(54) ULTRA-HIGH ENDURANCE STORAGE CLASS MEMORY AS A HOST DATA BUFFER IN A MEMORY SUB-SYSTEM

(71) Applicant: Micron Technology, Inc., Boise, ID (US)

(72) Inventors: Kishore Kumar Muchherla, San Jose, CA (US); Suresh Rajgopal, San Diego, CA (US); William Akin, Morgan Hill, CA (US); John E. Maroney, Irvine, CA (US); Akira Goda, Tokyo (JP); William Melton, Shingle Springs, CA (US); Mark A. Helm, Santa Cruz, CA (US)

(21) Appl. No.: 18/970,013

(22) Filed: Dec. 5, 2024

Related U.S. Application Data
(60) Provisional application No. 63/607,800, filed on Dec. 8, 2023.

(51) Int. Cl. G06F 3/06

(52) U.S. Cl. CPC G06F 3/0656; G06F 3/0614; G06F 3/0631; G06F 3/0673

(57) ABSTRACT

A processing device in a memory sub-system receives host data to be stored in a memory sub-system including a memory device and an ultra-high endurance storage class memory device. The processing device further causes the host data to be stored in a host data buffer of the ultra-high endurance storage class memory device. The processing device causes a first portion of the host data stored in the host data buffer to be overwritten during a buffer tenure. In response to determining that a second portion of the host data satisfied a buffer tenure requirement, causing the second portion of the host data to be written from the host data buffer to the primary memory of the memory device.

### CROSS-REFERENCE TO RELATED APPLICATION

This application claims the benefit of U.S. Provisional Application No. 63/607,800, titled “Ultra-high Endurance Storage Class Memory as a Host Data Buffer in a Memory Sub-system,” filed Dec. 8, 2023, which is hereby incorporated herein by reference in its entirety.

### TECHNICAL FIELD

Embodiments of the disclosure relate generally to memory sub-systems, and more specifically, relate to using ultra-high endurance storage class memory as a host data buffer to filter overwritten data in a memory sub-system.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various embodiments of the disclosure.

FIG. 1 illustrates an example computing system that includes a memory sub-system in accordance with one or more embodiments of the present disclosure.

FIG. 2 is a block diagram illustrating a memory sub-system configured for a portion of an ultra-high endurance storage class memory device to manage the storage of host data, in accordance with one or more embodiments of the present disclosure.

FIG. 3 is a block diagram illustrating a memory sub-system configured for using a portion of an ultra-high endurance storage class memory device to manage storage of host data, in accordance with one or more embodiments of the present disclosure.

FIG. 4 is a flow diagram of an example method of overwriting a portion of host data stored in a portion of an ultra-high endurance storage class memory device, in accordance with one or more embodiments of the present disclosure.

FIG. 5 is a flow diagram of an example method of adjusting a size of a portion of an ultra-high endurance storage class memory device configured as a buffer to store host data, in accordance with one or more embodiments of the present disclosure.

FIG. 6 is a block diagram of an example computer system in which embodiments of the present disclosure may operate.

### DETAILED DESCRIPTION

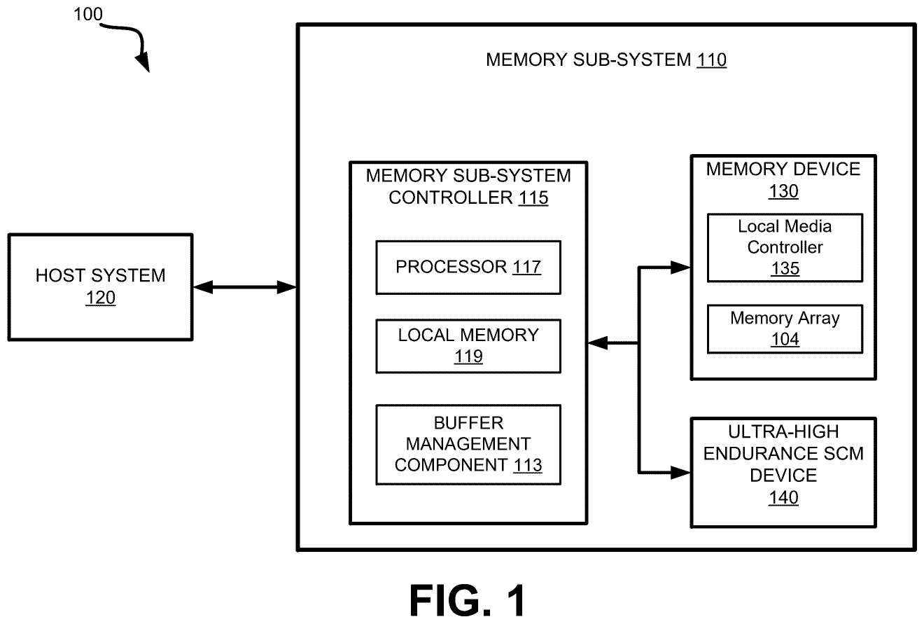

Aspects of the present disclosure are directed to using ultra-high endurance storage class memory as a buffer to filter overwritten data in a memory sub-system. A memory sub-system can be a storage device, a memory module, or a hybrid of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. For example, NAND memory, such as 3D flash NAND memory, offers storage in the form of compact, high density configurations. A non-volatile memory device is a package of one or more dice, each including one or more planes. For some types of non-volatile memory devices (e.g., NAND memory), each plane includes of a set of physical blocks. Each block includes of a set of pages. Each page includes of a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

A memory device can be made up of bits arranged in a two-dimensional or a three-dimensional grid. Memory cells are formed onto a silicon wafer in an array of columns (also hereinafter referred to as bitlines) and rows (also hereinafter referred to as wordlines). A wordline can refer to one or more rows of memory cells of a memory device that are used with one or more bitlines to generate the address of each of the memory cells. The intersection of a bitline and wordline constitutes the address of the memory cell. A block hereinafter refers to a unit of the memory device used to store data and can include a group of memory cells, a wordline group, a wordline, or individual memory cells. One or more blocks can be grouped together to form separate partitions (e.g., planes) of the memory device in order to allow concurrent operations to take place on each plane.

One example of a memory sub-system is a solid-state drive (SSD) that includes one or more non-volatile memory devices and a memory sub-system controller to manage the non-volatile memory devices. A given segment of one of those memory devices (e.g., a block) can be characterized based on the programming state of the memory cells associated with wordlines contained within the segment. Some memory devices use certain types of memory cells, such as quad-level cell (QLC) memory cells, which store four bits of data in each memory cell, which make it affordable to move more applications from legacy hard disk drives to newer memory sub-systems, such as NAND solid-state drives (SSDs). QLC memory is particularly well-tuned for read-intensive workloads, which are often seen in data center applications where data is normally generated once, and then read regularly to perform calculations and analysis. Thus, QLC memory is often considered to be fragile and used only for very light write workloads, as the endurance and Quality of Service (QOS) can limit usability in data center applications.

Aspects of the present disclosure address the above and other deficiencies by using ultra-high endurance storage class memory as a buffer to store host data for a buffer tenure, prior to writing at least a portion of the host data to a memory device in a memory sub-system. Ultra-high endurance storage class memory can include any of a number of different types of memory media that are non-volatile, offer lower program/read latency and utilize less energy per bit than 3D NAND flash memory. Some examples of ultra-high endurance storage class memory include hybrid random access memory (HRAM), three-dimensional cross-point (“3D cross-point”) memory, or others. Depending on the embodiment, the ultra-high endurance storage class memory can be implemented within the same package as the NAND memory (i.e., within the same memory sub-system), or can be separately packaged.

In one embodiment, host data associated with one or more memory access operations is stored to an ultra-high endurance storage class memory configured as a buffer (also referred to as a “buffer” or “host data buffer”). In an embodiment, a portion of the ultra-high endurance storage class memory device is allocated as the host data buffer to store the host data, prior to writing the host data to the primary memory device (i.e., the NAND flash memory). In an embodiment, a portion of the host data subject stored in the host data buffer of the ultra-high endurance storage class memory device is overwritten by the host system (also referred to as “super hot data”). Advantageously, the host data buffer of the ultra-high endurance storage class memory device as a serial pass filter to store and invalidate super hot data. This results in overwriting of host data in storage class memory resulting in less TBW in the primary memory device which improves the endurance of the primary memory device. Furthermore, a portion of the host data may be overwritten by other data while “soaking” or stored in the host data buffer of the ultra-high endurance storage class memory device, prior to writing the host data to the primary memory device. Accordingly, since the overwritten portion of the host data is invalidated in the host data buffer of the ultra-high endurance storage class memory device, the amount of valid data (i.e., a net total bytes written (TBW)) that is written to the memory device decreases. Accordingly, it is advantageous to overwrite the data in the host data buffer of the ultra-high endurance storage class memory device as opposed to overwriting the data in the memory device.

According to embodiments, the total bytes written to the memory device is a function of a size of the host data buffer of the ultra-high endurance storage class memory device. In an embodiment, the size of the host data buffer of the ultra-high endurance storage class memory device is dynamically adjusted based on an amount of host data that is overwritten in the host data buffer of the ultra-high endurance storage class memory device (also referred to as an “amount of overwritten data”). In an embodiment, an amount of the overwritten data (i.e., the host data overwritten in the host data buffer of the ultra-high endurance storage class memory device) is determined and compared to a threshold level to determine if a first condition or a second condition is satisfied. In an embodiment, the first condition is satisfied if the amount of overwritten data exceeds the threshold level. In an embodiment, in response to satisfying the first condition, a size of the host data buffer is increased from a first or current size to a second size. In an embodiment, the second condition is satisfied if the amount of overwritten data is less than or equal to the threshold level. In an embodiment, in response to satisfying the second condition, the size of the host data buffer is decreased (i.e., decreased from a first size to a second size). Advantageously, dynamically adjusting the size of the host data buffer of the ultra-high endurance storage class memory device based on the amount of overwritten data optimizes the use of the ultra-high endurance storage class memory device by multiple different applications of the memory device.

In an embodiment, the amount of overwritten host data may be monitored and determined on a periodic basis (e.g., at a predetermined time interval). In an embodiment, the amount or size of the adjustment (i.e., the amount of the increase from the first size to the second size) may be based on the amount the overwritten host data exceeds the threshold level.

Advantages of the above-identified approaches include, but are not limited to, improved performance in the memory sub-system and an improvement of the endurance of the memory device. Since ultra-high endurance storage class memory has higher endurance than QLC or SLC NAND memory, it is advantageous to overwrite super hot data stored in the host data buffer implemented using ultra-high endurance storage class memory, as compared to overwriting data stored in the memory device. Since larger portions of the NAND memory need not be dedicated for use as a data buffer, the overall storage capacity of the memory sub-system can be increased.

FIG. 1 illustrates an example computing system 100 that includes a memory sub-system 110 in accordance with some embodiments of the present disclosure. The memory sub-system 110 can include media, such as one or more ultra-high endurance storage class memory devices (e.g., memory device 140), one or more non-volatile memory devices (e.g., one or more memory device(s) 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-system 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access the memory components (e.g., the one or more memory device(s) 130) when the memory sub-system 110 is coupled with the host system 120 by the PCIe interface. The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. For example, the ultra-high endurance storage class memory device 140 can include any of a number of different types of memory media or “cells” that are non-volatile and offer lower program/read latency than 3D NAND type flash memory, including both SLC memory and QLC memory. In addition, the ultra-high endurance storage class memory device 140 can have higher endurance (i.e., can tolerate a greater number of program/erase cycles) than memory device 130. Some examples of ultra-high endurance storage class memory include hybrid random access memory (HRAM), three-dimensional cross-point (“3D cross-point”) memory, or others.

Some examples of non-volatile memory devices (e.g., memory device(s) 130) include not-and (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory device(s) 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), or penta-level cells (PLCs) can store multiple bits per cell. In some embodiments, each of the memory devices 130 can include one or more arrays of memory cells such as SLCs, MLCs, TLCs, QLCs, PLCs, or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), not-or (NOR) flash memory, electrically erasable programmable read-only memory (EEPROM).

A memory sub-system controller 115 (or controller 115 for simplicity) can communicate with the memory device(s) 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor 117 (e.g., a processing device) configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory device(s) 130. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory device(s) 130. The memory sub-system controller 115 can further include host interface circuitry to communicate with the host system 120 via the physical host interface. The host interface circuitry can convert the commands received from the host system into command instructions to access the memory device(s) 130 as well as convert responses associated with the memory device(s) 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory device(s) 130.

In some embodiments, the memory device(s) 130 include local media controllers 135 that operate in conjunction with memory sub-system controller 115 to execute operations on one or more memory cells of the memory device(s) 130. An external controller (e.g., memory sub-system controller 115) can externally manage the memory device 130 (e.g., perform media management operations on the memory device(s) 130). In some embodiments, a memory device 130 is a managed memory device, which is a raw memory device (e.g., memory array 104) having control logic (e.g., local controller 135) for media management within the same memory device package. An example of a managed memory device is a managed NAND (MNAND) device. Memory device(s) 130, for example, can each represent a single die having some control logic (e.g., local media controller 135) embodied thereon. In some embodiments, one or more components of memory sub-system 110 can be omitted.

In one embodiment, the memory sub-system 110 includes a buffer management component 113 that can implement a host data management policy that utilizes ultra-high endurance storage class memory device 140 as a buffer for host data. In an embodiment, the buffer management component 113 initially writes the host data to a portion of ultra-high endurance storage class memory device 140 (i.e., the ultra-high endurance storage class memory device 140 serves as a buffer for the host data). According to embodiments, the host data is written to the ultra-high endurance storage class memory device 140. In an embodiment, the data is not moved from the ultra-high endurance storage class memory device 140 to the memory device until the buffer is full. This way, after data is written to buffer, the data stays in the ultra-high endurance storage class memory device 130 until the buffer size amount of host data is subsequently written. As host data consists of super-hot data which is immediately over-written in future operations, host data tends to be over-written while in the ultra-high endurance storage class memory device 140 itself. In an embodiment, after the ultra-high endurance storage class memory device 140 is full with host data, recently written data is not moved to the memory device 130 until the previous data sitting in the ultra-high endurance storage class memory device 140 is moved to the memory device 130. As a result, every host data written to the buffer stays in the buffer and not moved to memory device until additional host data is written to the buffer.

In an embodiment, the buffer management component 113 monitors an amount of host data overwritten in the ultra-high endurance storage memory device 140. In an embodiment, the amount of host data overwritten in the ultra-high endurance storage memory device 140 can be measured as a percentage of a total amount of host data stored in the ultra-high endurance storage memory device 140 during the time interval. In an embodiment, the buffer management component 113 compares the measured amount of overwritten data to a threshold level to determine if a first condition is satisfied or a second condition is satisfied. In an embodiment, the first condition is satisfied if the amount of overwritten data is greater than the threshold level. In an embodiment, if the first condition is satisfied, the buffer management component 113 can increase a size of a buffer portion of the ultra-high endurance storage memory device 140. In an embodiment, second condition is satisfied if the amount of overwritten data is less than or equal to than the threshold level. In an embodiment, if the second condition is satisfied, the buffer management component 113 can decrease a size of the buffer portion of the ultra-high endurance storage memory device 140. According to embodiments, the buffer management component 113 can iteratively repeat the monitoring and measuring of the overwritten data to dynamically adjust the size of the buffer of the ultra-high endurance storage memory device 140 based on the amount of host data overwritten in the ultra-high endurance storage memory device 140. Further details with regards to the operations of buffer management component 113 are described below.

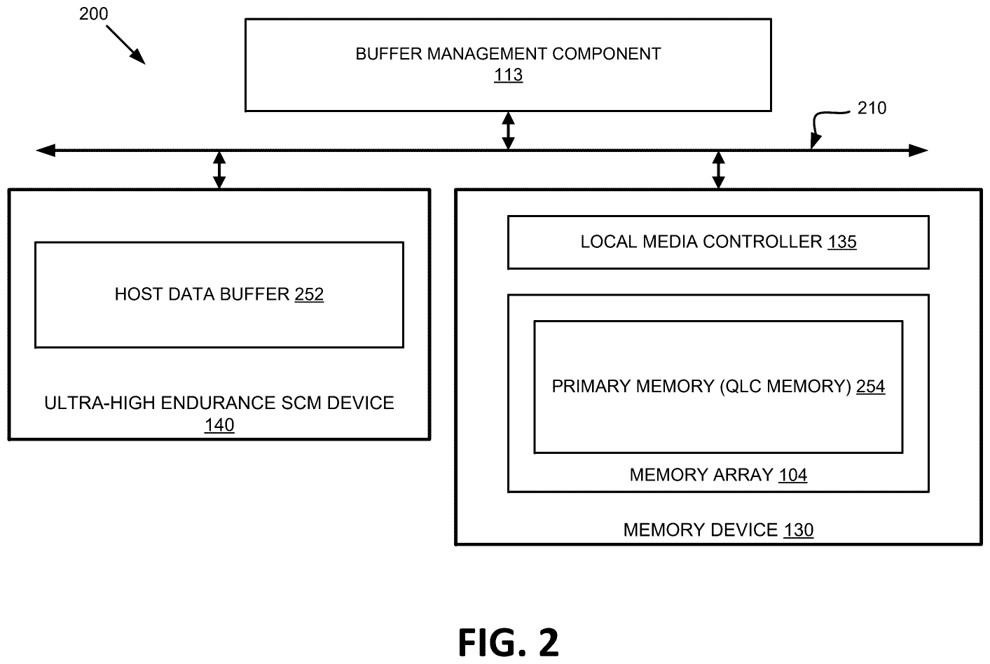

FIG. 2 is a block diagram 200 illustrating a memory sub-system configured for using ultra-high endurance storage class memory as a host data buffer in accordance with some embodiments of the present disclosure. In one embodiment, buffer management component 113 is operatively coupled with memory device 130 and with ultra-high endurance storage class memory device 140. For example, the memory sub-system may include a shared communication bus 210 between buffer management component 113, memory device 130, and ultra-high endurance storage class memory device 140, as well as possibly other components (not shown). In one embodiment, the communication bus 210 utilizes an Open NAND Flash Interface (ONFI) bus architecture to enhance data transfer rates in the memory subsystem. The ONFI bus architecture enables advanced data parallelism, dynamically adaptable error correction capabilities, and intelligent command queuing.

In one embodiment, memory device 130 includes local media controller 135 and memory array 104. Memory array 104 can include an array of memory cells formed at the intersections of wordlines and bitlines. In one embodiment, the memory cells are grouped in to blocks, which can be further divided into sub-blocks, where a given wordline is shared across a number of sub-blocks, for example. In one embodiment, each sub-block corresponds to a separate plane in the memory array 104. The group of memory cells associated with a wordline within a sub-block is referred to as a physical page. In one embodiment, there can be at least a portion of the memory array 104 where the sub-blocks are configured as QLC memory and which can be used as primary memory 254. Depending on how they are configured, each physical page in one of the sub-blocks can include multiple page types. For example, a physical page formed from single level cells (SLCs) has a single page type referred to as a lower logical page (LP). Multi-level cell (MLC) physical page types can include LPs and upper logical pages (UPs), TLC physical page types are LPs, UPs, and extra logical pages (XPs), and QLC physical page types are LPs, UPs, XPs and top logical pages (TPs). For example, a physical page formed from memory cells of the QLC memory type can have a total of four logical pages, where each logical page can store data distinct from the data stored in the other logical pages associated with that physical page. Depending on the embodiment, the primary memory 254 can be configured as some other type of memory besides QLC memory, such as multi-level cell (MLC) memory, triple level cell (TLC) memory, penta-level cell (PLC) memory, or any combination of such.

Depending on the programming scheme used, each logical page of a memory cell can be programmed in a separate programming pass, or multiple logical pages can be programmed together. For example, in a QLC physical page, the LP and UP can be programmed on one pass, and the XP and TP can be programmed on a second pass. Other programming schemes are possible. In one embodiment, buffer management component 113 can receive, for example, four pages of host data to be programmed to primary memory 254. Accordingly, in order for one bit from each of the four pages to be programmed to each memory cell, local media controller 135 can cause each memory cell to be programmed to one of 16 possible programming levels (i.e., voltages representing the 16 different values of those four bits). Thus, the four pages of host data will be represented by 16 different programming distributions.

In one embodiment, buffer management component 113 causes host data relating to one or more media access operations to be stored in a host data buffer 252 of the ultra-high endurance storage class memory device 140. According to embodiments, the host data can be stored in one or more data structures (e.g., tables) stored in the host data buffer 252 of the ultra-high endurance storage class memory device 140, such that the data structures can be read from or written to by the buffer management component 113. In an embodiment, the host data stored in the host data buffer 252 can be overwritten by the host system. In an embodiment, following completion of a time interval, the host data stored in the host data buffer 252 can be written from the ultra-high endurance storage class memory device 140 to a primary memory 254 of the memory device 130. Advantageously, the host data that is overwritten during the buffer tenure (i.e., a time since data is written to the ultra-high endurance storage class memory device 140 to when it is moved to the primary memory 254 when it becomes the oldest data in the ultra-high endurance storage class memory device 140) is invalidated by the host system and not written to the primary memory 254. In an embodiment, overwriting a portion of the host data stored in the host data buffer 252 enables the buffer management component 113 to avoid writing invalid data to the primary memory 254 of the memory device 130, which improves the endurance of the memory device 130.

In an embodiment, a size of the host data buffer 252 (e.g., a size of a portion of the ultra-high endurance storage class memory device 140 allocated as a buffer for the host data) can be dynamically adjusted based on an amount of data stored in the host data buffer 252 that is overwritten by the host system. In an embodiment, the buffer management component 113 monitors and measures an amount of data that is overwritten in the host data buffer 252 (e.g., a percentage of the overwritten data of a total amount of host data written to the host data buffer 252). In an embodiment, the measured amount of overwritten data (e.g., the percentage) is compared to a threshold level to determine if a first condition is satisfied (i.e., the percentage of overwritten data is greater than the threshold level) or a second condition is satisfied (i.e., the percentage of overwritten data is less than threshold level). In an embodiment, in response to satisfying the first condition, the buffer management component 113 can increase the size of the host data buffer 252 (i.e., allocate a larger portion of the ultra-high endurance storage class memory device 140 as the host data buffer 252). In an embodiment, in response to satisfying the second condition, the buffer management component 113 can decrease the size of the host data buffer 252 (i.e., allocate a smaller portion of the ultra-high endurance storage class memory device 140 as the host data buffer 252).

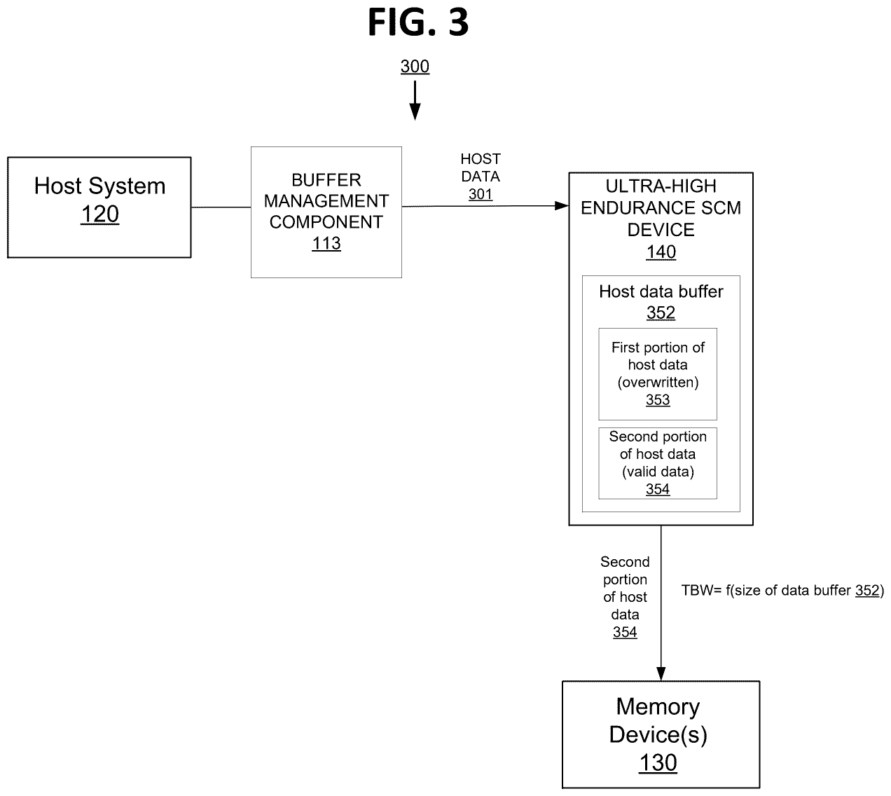

FIG. 3 is a block diagram 300 illustrating components of a memory sub-system configured for using an ultra-high endurance storage class memory device 140 to store host data associated with one or more media access operations, in accordance with embodiments of the present disclosure. Advantageously, the ultra-high endurance SCM device 140 is a non-volatile and persistent memory location.

As illustrated in FIG. 3, a host system 120 generates host data 301 relating to one or more media access operations associated with one or more memory devices 130. The buffer management component 113 causes the host data 301 to be stored in a host data buffer 352 of an ultra-high endurance storage class storage memory device 140. In an embodiment, the buffer management component 113 causes the host data 301 to be stored in the host data buffer 352 for a buffer tenure (i.e., a time spent in the buffer before being moved to the memory device 130) at the end of which the buffer management component 113 causes at least a portion of the host data 301 to be written to one or more memory devices 130.

In an embodiment, while the host data 301 is stored in the host data buffer 352, a first portion of the host data 353 may be overwritten by the host system 120 (i.e., invalid data) during the buffer tenure. Accordingly, the buffer management component 113 causes the first portion of the host data 353 to be overwritten or invalidated. In an embodiment, at the end of the buffer tenure, the buffer management component 113 causes a second portion of the host data 354 (i.e., the host data stored in the host data buffer 352 that is not overwritten (i.e., valid data) to be written to the one or more memory devices 130. Accordingly, a total bytes written (TBW) to the one or more memory devices 130 can be managed by the buffer management component 113 as a function of the size of the host data buffer 352. In an embodiment, the buffer management component 113 can adjust (i.e., increase or decrease) the size of the host data buffer 352 based on an amount of host data overwritten while stored in the host data buffer 352 (i.e., a size of the first portion of the host data 353).

According to embodiments, causing the host data 301 to be “soaked” or stored in the host data buffer 352 of the ultra-high endurance storage class memory 140 for the buffer tenure enables the super hot data to be overwritten by the host system 120 prior to writing that data to the one or more memory devices 130. Advantageously, overwriting the host data while stored in the host data buffer 352 of the ultra-high endurance storage class memory device 140 reduces the effective TBW written to the one or more memory devices 130 and improves the endurance of the one or more memory devices 130.

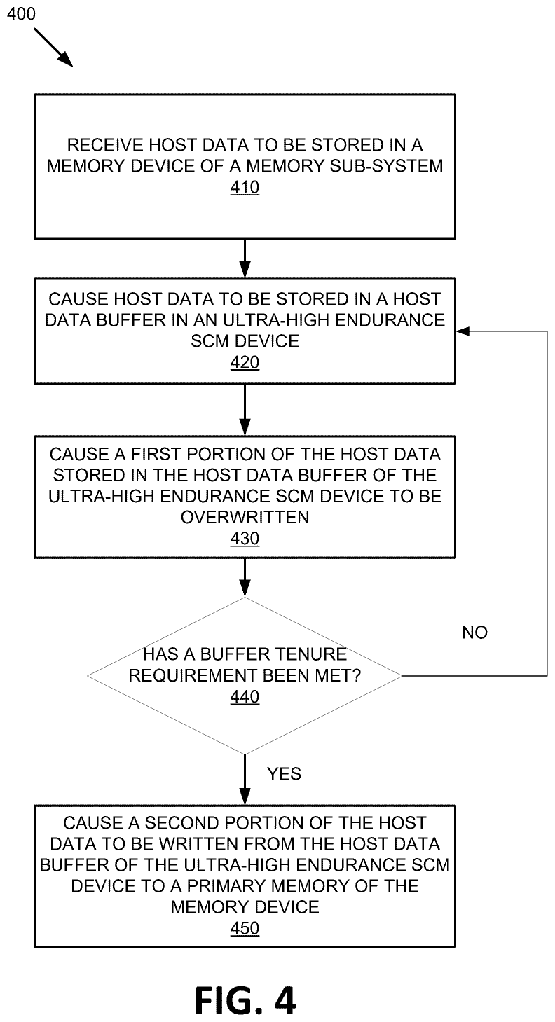

FIG. 4 is a flow diagram of an example method of using ultra-high endurance storage class memory to store host data associated with one or more media access operations in a host data buffer portion of an ultra-high endurance storage class memory device, in accordance with one or more embodiments of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by buffer management component 113 of FIGS. 1-3. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 410, the processing logic (e.g., buffer management component 113) receives host data to be stored in a memory device of a memory sub-system. In an embodiment, the host data relates to one or more memory access operations associated with the memory device (e.g., a NAND memory device).

At operation 420, the processing logic causes the host data to be stored in a buffer in an ultra-high endurance storage class memory device (e.g., ultra-high endurance storage class memory device 140 of FIGS. 1-3). In an embodiment, the processing logic allocates a portion of the ultra-high endurance storage class memory device as the buffer to store the host data for a buffer tenure (i.e., a time during which the host data is stored in the buffer of the ultra-high endurance storage class memory device before being moved to the memory device).

At operation 430, the processing logic causes a first portion of the host data stored in the host data buffer of the ultra-high endurance storage class memory device to be overwritten by the host system. Advantageously, the first portion of the host data (i.e., super hot data) is overwritten by the host system while stored in the host data buffer of the ultra-high endurance storage class memory device, prior to being written to a primary memory of the memory device.

At operation 440, the processing logic determines if a second portion of the host data satisfies a buffer tenure requirement (i.e., the second portion is the oldest data in the host data buffer and is ready to be written to the memory device).

At operation 450, the processing logic causes writing of a second portion of the host data from the host data buffer of the ultra-high endurance storage class memory device to the memory device. In an embodiment, the second portion of the host data includes a valid data portion of the host data stored in the host data buffer at a time the buffer time threshold is met. In an embodiment, the second portion of the host data includes host data that is not overwritten while stored in the host data buffer.

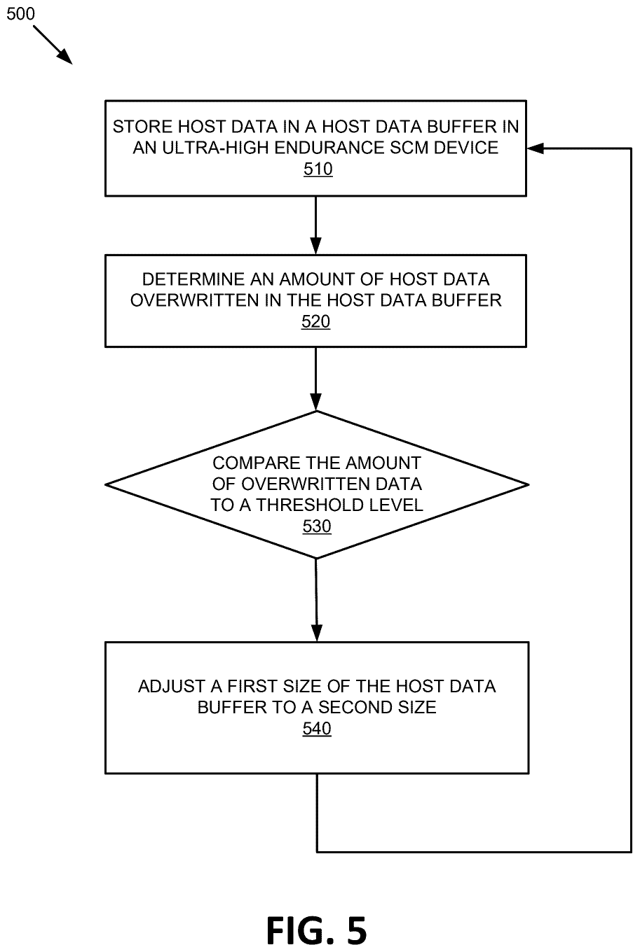

FIG. 5 is a flow diagram of an example method of adjusting a size of a buffer portion of an ultra-high endurance storage class memory, where the buffer portion stores host data associated with one or more media access operations relating to one or more memory devices of a memory sub-system, in accordance with one or more embodiments of the present disclosure. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 500 is performed by buffer management component 113 of FIGS. 1-3. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 510, the processing logic causes the host data to be stored in a host data buffer in an ultra-high endurance storage class memory device (e.g., ultra-high endurance storage class memory device 140 of FIGS. 1-3). In an embodiment, the processing logic allocates a portion of the ultra-high endurance storage class memory device as the host data buffer to store the host data during a buffer tenure, where the host data buffer has a first size.

At operation 520, the processing logic determines an amount of host data that is overwritten in the host data buffer. In an embodiment, at the end of a buffer tenure, the processing logic measures an amount of the host data that has been overwritten during the buffer tenure. In an embodiment, the amount of overwritten data is determined as a percentage of the total host data stored in the host data buffer during the buffer tenure. For example, the processing logic can determine that 25% of the total host data stored in the host data buffer was overwritten during the buffer tenure.

At operation 530, the processing logic compares the amount of overwritten data (i.e., the percentage of the total host data that is overwritten during the buffer tenure) is greater than a threshold level. In an embodiment, the comparison of the amount of overwritten data to the threshold level is used to determine an adjustment to a current or first size of the host data buffer. According to embodiments, the size of the host data buffer is adjusted by changing the amount the ultra-high endurance storage class memory device that is allocated for use as the host data buffer.

At operation 540, the processing logic adjusts a first size of the host data buffer to a second size in view of the comparison of the amount of overwritten data to the threshold level. In an embodiment, if the amount of overwritten data is greater than the threshold level, the processing logic increases the size of the host data buffer (i.e., the second size is greater than the first size). In an embodiment, if the amount of overwritten data is less than the threshold level, the processing logic decreases the size of the host data buffer (i.e., the second size is greater than the first size).

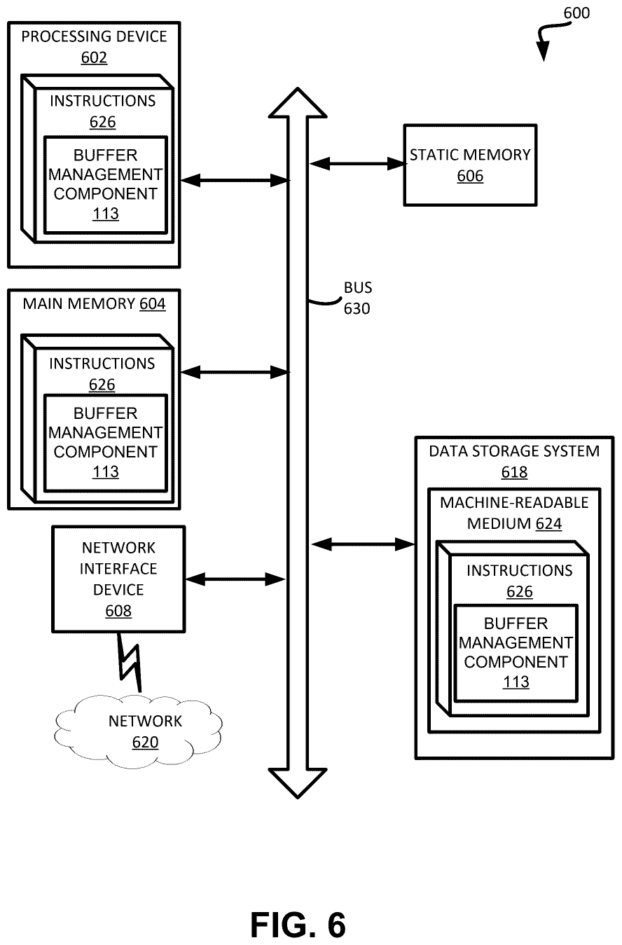

FIG. 6 illustrates an example machine of a computer system 600 within which a set of instructions, for causing the machine to perform any one or more of the methodologies discussed herein, can be executed. In some embodiments, the computer system 600 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the buffer management component 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random access memory (DRAM) such as synchronous DRAM (SDRAM) or Rambus DRAM (RDRAM), etc.), a static memory 606 (e.g., flash memory, static random access memory (SRAM), etc.), and a data storage system 618, which communicate with each other via a bus 630.

Processing device 602 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 602 can also be one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein. The computer system 600 can further include a network interface device 608 to communicate over the network 620.

The data storage system 618 can include a machine-readable storage medium 624 (also known as a computer-readable medium) on which is stored one or more sets of instructions 626 or software embodying any one or more of the methodologies or functions described herein. The instructions 626 can also reside, completely or at least partially, within the main memory 604 and/or within the processing device 602 during execution thereof by the computer system 600, the main memory 604 and the processing device 602 also constituting machine-readable storage media. The machine-readable storage medium 624, data storage system 618, and/or main memory 604 can correspond to the memory sub-system 110 of FIG. 1.

In one embodiment, the instructions 626 include instructions to implement functionality corresponding to the buffer management component 113 of FIG. 1). While the machine-readable storage medium 624 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A memory sub-system comprising:
a memory device configured as primary memory;
an ultra-high endurance storage class memory device comprising a portion allocated as a host data buffer; and
a processing device, operatively coupled with the memory device and the ultra-high endurance storage class memory device, to perform operations comprising:
receiving host data to be stored in the memory device;
causing the host data to be stored in the host data buffer of the ultra-high endurance storage class memory device;
causing a first portion of the host data stored in the host data buffer to be overwritten during a buffer tenure; and
in response to determining that a second portion of the host data satisfied a buffer tenure requirement, causing the second portion of the host data to be written from the host data buffer to the primary memory of the memory device.

2. The memory sub-system of claim 1, wherein the second portion of the host data comprises valid data that is not overwritten during the buffer tenure.

3. The memory sub-system of claim 1, the operations further comprising allocating the host data buffer having a first size.

4. The memory sub-system of claim 1, the operations further comprising determining an amount of host data overwritten during the buffer tenure.

5. The memory sub-system of claim 4, the operations further comprising comparing the amount of host data overwritten during the buffer tenure to a threshold level.

6. The memory sub-system of claim 5, the operations further comprising increasing a first size of the host data buffer to a second size in response to determining the amount of host data overwritten during the buffer tenure is greater than the threshold level.

7. The memory sub-system of claim 5, the operations further comprising decreasing a first size of the host data buffer to a second size in response to determining the amount of host data overwritten during the buffer tenure is less than the threshold level.

8. A method comprising:
receiving, by a processing device, host data to be stored in a memory device of a memory sub-system;
causing the host data to be stored in a host data buffer of an ultra-high endurance storage class memory device of the memory sub-system;
causing a first portion of the host data stored in the host data buffer to be overwritten during a buffer tenure; and
in response to determining that a second portion of the host data satisfied a buffer tenure requirement, causing the second portion of the host data to be written from the host data buffer to the primary memory of the memory device.

9. The method of claim 8, wherein the second portion of the host data comprises valid data that is not overwritten during the buffer tenure.

10. The method of claim 8, further comprising allocating the host data buffer having a first size at a first time.

11. The method of claim 8, further comprising determining an amount of host data overwritten during the buffer tenure.

12. The method of claim 11, further comprising comparing the amount of host data overwritten during the buffer tenure to a threshold level.

13. The method of claim 12, further comprising increasing a first size of the host data buffer to a second size in response to determining the amount of host data overwritten during the buffer tenure is greater than the threshold level.

14. The method of claim 12, further comprising decreasing a first size of the host data buffer to a second size in response to determining the amount of host data overwritten during the buffer tenure is less than the threshold level.

15. A non-transitory computer-readable storage medium comprising instructions that, when executed by a processing device, cause the processing device to perform operations comprising:
receiving host data to be stored in a memory device of a memory sub-system;
causing the host data to be stored in a host data buffer of an ultra-high endurance storage class memory device of the memory sub-system;
causing a first portion of the host data stored in the host data buffer to be overwritten during a buffer tenure; and
in response to determining that a second portion of the host data satisfied a buffer tenure requirement, causing the second portion of the host data to be written from the host data buffer to the primary memory of the memory device.

16. The non-transitory computer-readable storage medium of claim 15, wherein the second portion of the host data comprises valid data that is not overwritten during the buffer tenure.

17. The non-transitory computer-readable storage medium of claim 15, the operations further comprising allocating the host data buffer having a first size at a first time.

18. The non-transitory computer-readable storage medium of claim 15, the operations further comprising:
determining an amount of host data overwritten during the buffer tenure; and
comparing the amount of host data overwritten during the buffer tenure to a threshold level.

19. The non-transitory computer-readable storage medium of claim 18, the operations further comprising increasing a first size of the host data buffer to a second size in response to determining the amount of host data overwritten during the buffer tenure is greater than the threshold level.

20. The non-transitory computer-readable storage medium of claim 18, the operations further comprising decreasing a first size of the host data buffer to a second size in response to determining the amount of host data overwritten during the buffer tenure is less than the threshold level.
